(19) United States
(12) Patent Application Publication
(10) Pub. No.: US 2026/0196000 A1
(43) Pub. Date: Jul. 9, 2026

(54) METHOD FOR DETERMINING COLOR DIFFERENCE DEFECT COMPENSATION DATA, COMPENSATION METHOD, AND AUGMENTED REALITY DEVICE

(71) Applicant: AAC ACOUSTIC TECHNOLOGIES (SHENZHEN) CO., LTD., Shenzhen (CN)

(72) Inventors: Min Jiang, Shenzhen (CN); Yang Li, Shenzhen (CN); Hongyan Tao, Shenzhen (CN)

(21) Appl. No.: 19/389,096

(22) Filed: Nov. 14, 2025

Related U.S. Application Data
(63) Continuation of application No. PCT/CN2025/070350, filed on Jan. 3, 2025.

(51) Int. Cl. G06T 19/00; G06T 5/20; G06T 5/70; G06T 7/194; G06T 7/90; G06V 10/56; G09G 5/02

(52) U.S. Cl. CPC G06T 19/006; G06T 5/20; G06T 5/70; G06T 7/194; G06T 7/90; G06V 10/56; G09G 5/02; G06T 2207/10024; G06V 2201/07; G09G 2320/0242; G09G 2320/0666

(57) ABSTRACT

The present invention provides a method for determining color difference defect compensation data, a compensation method, and an augmented reality device. The method for determining color difference defect compensation data, including: obtaining a generated image of an augmented reality device, and preprocessing the generated image to obtain a first image; using a preset filtering algorithm to detect a color difference defect in the first image; obtaining a position of the color difference defect region and color difference defect data; and generating corresponding color difference defect compensation data based on the color difference defect data. According to the method for determining the color difference defect compensation data provided in the embodiments of the present invention, to compensate for display content of an augmented reality display apparatus and obtain a compensated display picture, thereby enhancing a display effect of the augmented reality display apparatus and correcting a color difference.

### CROSS-REFERENCE TO RELATED APPLICATIONS

This application is a continuation of International Application No. PCT/CN2025/070350, filed on Jan. 3, 2025, the entire content of which is incorporated herein by reference.

### TECHNICAL FIELD

The present invention relates to the field of augmented reality, and in particular to, a method for determining color difference defect compensation data, a compensation method, and an augmented reality device.

### BACKGROUND

In an augmented reality (AR) technology, a waveguide display technology is a commonly used implementation that presents a virtual image by guiding light to the eyes of a user. However, an existing AR glasses waveguide display technology may affect the quality of a generated image due to defects of a waveguide and defects of a display panel. Due to the propagation and refraction of light in a waveguide material and inherent defects of the display panel, defects such as nonuniform brightness of an image, a color difference, distortion of image chromaticity information, a granular sensation in an image, and nonuniform pixels may be caused. These differences are referred to as an AR display color difference defect. With an increasing demand for the imaging quality of an AR display device, there is an urgent need for a method for correcting an AR display color difference defect, to improve the imaging quality of the AR display device.

### SUMMARY

Embodiments of the present invention provide a method for determining color difference defect compensation data, a compensation method, and an augmented reality device, to correct an AR display color difference defect, thereby improving imaging quality of an AR display device.

In the first aspect, the present application provides a method for determining color difference defect compensation data, including: obtaining a generated image of an augmented reality device, and preprocessing the generated image to obtain a first image; using a preset filtering algorithm to detect a color difference defect in the first image; in a case that a color difference defect has been detected, identifying a corresponding color difference defect region, and obtaining a position of the color difference defect region and color difference defect data; and generating corresponding color difference defect compensation data based on the color difference defect data, and providing the position of the color difference defect region and the corresponding color difference defect compensation data to the augmented reality device for color difference defect compensation.

In one possible implementation, the obtaining a generated image of an augmented reality device, and preprocessing the generated image to obtain a first image includes: obtaining the generated image output by an image output end of the augmented reality device, the generated image is acquired by using an imaging colorimeter and photographic equipment; detecting a subject and a background of the generated image, removing the background of the generated image, and retaining the subject of the generated image; and performing image enhancement on the subject of the generated image to obtain the first image, the image enhancement includes at least one of the following: adjusting brightness and/or contrast of the subject of the generated image; using an anti-aliasing algorithm and/or a low-pass filter to reduce a moire pattern phenomenon; using a spatial filter to smooth the image and reduce noise; and correcting image distortion.

In one possible implementation, the using a preset filtering algorithm to detect a color difference defect in the first image includes: determining sizes of edge detection filters that respectively correspond to different color difference defects and detection thresholds that respectively correspond to different color difference defects; for each color difference defect, traversing pixels of the first image based on the size of the edge detection filter corresponding to the color difference defect, performing convolution operation, and comparing an operation result obtained in each operation with the detection threshold corresponding to the color difference defect; and in a case that the operation result satisfies the detection threshold corresponding to the color difference defect, determining that a corresponding pixel has the color difference defect.

In one possible implementation, in a case that a color difference defect has been detected, the identifying a corresponding color difference defect region, and obtaining a position of the color difference defect region and color difference defect data includes: for each color difference defect, in a case that it is determined that a first pixel of the first image has the color difference defect, determining position coordinates of the first pixel having the color difference defect in the first image; determining the color difference defect region with the color difference defect and the position of the color difference defect region in the first image based on a positional relationship between the position coordinates of the first pixel; and determining the color difference defect data corresponding to the color difference defect region based on a display index value of a pixel within the color difference defect region; and/or the color difference defect includes: a point color difference defect, a line color difference defect, and a band color difference defect; the edge detection filter corresponding to the point color difference defect includes a one-dimensional filter; and the edge detection filters corresponding to the line color difference defect and the band color difference defect include one-dimensional filters.

In one possible implementation, the generating corresponding color difference defect compensation data based on the color difference defect data, and providing the position of the color difference defect region and the corresponding color difference defect compensation data to the augmented reality device for color difference defect compensation includes: for each first pixel in each color difference defect region, determining, based on a preset compensation mode from pixels that are adjacent to the first pixel and have no color difference defect, pixel values and position coordinates of at least two second pixels having a preset positional relationship with the first pixel; determining color difference defect compensation data corresponding to the first pixel based on a pixel value and position coordinates of the first pixel and the pixel values and position coordinates of the second pixels; determining, in the color difference defect region, color difference defect subregions corresponding to first pixels having close color difference defect compensation data; and providing positions of the color difference defect subregion and corresponding color difference defect compensation data to the augmented reality device for color difference defect compensation.

In one possible implementation, the for each first pixel in each color difference defect region, determining, based on a preset compensation mode from pixels that are adjacent to the first pixel and have no color difference defect, pixel values and position coordinates of at least two second pixels having a preset positional relationship with the first pixel includes: in a case that the preset compensation mode employs a one-dimensional compensation mode, for each first pixel in each color difference defect region, determining, from the pixels that are adjacent to the first pixel and have no color difference defect, pixel values and one-dimensional position coordinates of at least two second pixels with one-dimensional coordinate values respectively less than and greater than a one-dimensional coordinate value of the first pixel; and in a case that the preset compensation mode employs a two-dimensional compensation mode, for each first pixel in each color difference defect region, respectively determining, from the pixels that are adjacent to the first pixel and have no color difference defect, pixel values and two-dimensional position coordinates of a plurality of second pixels, the two-dimensional position coordinates of the plurality of second pixels satisfying: connecting the plurality of second pixels in sequence is able to surround the first pixel.

In one possible implementation, the method the using a preset filtering algorithm to detect a color difference defect in the first image further includes: using a smoothing filter to traverse pixels of the first image and perform convolution operation, to smooth an edge of the color difference defect in the first image, the smoothing filter includes a two-dimensional filter; alternatively, in a case that the edge detection filter is a one-dimensional filter, the smoothing filter is used as another one-dimensional filter to form a two-dimensional filter with the edge detection filter, for each color difference defect, using the following mode to determine the detection threshold corresponding to the color difference defect: for each color difference defect, comparing, by edge detection filters with the same size for the color difference defect, different candidate detection thresholds with corresponding operation results to obtain different comparison results; using a preset edge detection algorithm to compare the color difference defect that is determined based on the comparison result of each candidate detection threshold with a corresponding color difference defect region in the first image, to determine valid degrees of the candidate detection thresholds for detecting the corresponding color difference defect; and determining a candidate detection threshold with a highest valid degree as the detection threshold corresponding to the color difference defect.

In the second aspect, a color difference defect compensation method, including: receiving a power-on instruction; starting a display optimization service to read a color difference defect compensation parameter from a preset storage medium, and loading the color difference defect compensation parameter into an internal memory, the color difference defect compensation parameter includes: a position and color difference defect compensation data of a color difference defect region; calling a display service to read the color difference defect compensation parameter from the internal memory, and updating the color difference defect compensation parameter to a preset register inside a preset processor; and controlling a display panel to compensate for graphics processing unit (GPU)-rendered display data based on the color difference defect compensation parameter in the preset register, the color difference defect compensation parameter is determined based on the method for determining the color difference defect compensation data as described in the first aspect.

In one possible implementation, a first compensation parameter storage register is configured in a data processing unit (DPU); the calling a display service to read the color difference defect compensation parameter from the internal memory, and updating the color difference defect compensation parameter to a preset register inside a preset processor includes: calling the display service to read the color difference defect compensation parameter from the internal memory, and updating the color difference defect compensation parameter to the first compensation parameter storage register in the DPU; the controlling a display panel to compensate for GPU-rendered display data based on the color difference defect compensation parameter in the preset register includes: transmitting the color difference defect compensation parameter in the first compensation parameter register to a preset internal memory of a display controller in the display panel through a mobile industry processor interface (MIPI) bus; the display controller compensates for the GPU-rendered display data based on the color difference defect compensation parameter in the preset memory; or a second compensation parameter storage register is configured in the display controller of the display panel; the calling a display service to read the color difference defect compensation parameter from the internal memory, and updating the color difference defect compensation parameter to a preset register inside a preset processor includes: calling the display service to read the color difference defect compensation parameter from the internal memory, and updating the color difference defect compensation parameter to a memory of the display panel; and reading the color difference defect compensation parameter to the second compensation parameter storage register inside the display controller through the display controller; and the controlling a display panel to compensate for GPU-rendered display data based on the color difference defect compensation parameter in the preset register includes: controlling the display panel to compensate for the GPU-rendered display data based on the color difference defect compensation parameter in the second compensation parameter storage register.

In the third aspect, an augmented reality device, including: a display panel, an optical waveguide, and an image processing device, the optical waveguide is configured to transmit content displayed on the display panel to the eyes of a user; and the image processing device is configured to: drive the display panel, store a color difference defect compensation parameter, and use the color difference defect compensation method as described in the first aspect. to compensate for data displayed by the display panel.

The present invention has the following beneficial effects.

The present invention provides a method for determining color difference defect compensation data, a compensation method, and an augmented reality device. The method for determining color difference defect compensation data, including: obtaining a generated image of an augmented reality device, and preprocessing the generated image to obtain a first image; using a preset filtering algorithm to detect a color difference defect in the first image; in a case that a color difference defect has been detected, identifying a corresponding color difference defect region, and obtaining a position of the color difference defect region and color difference defect data; and generating corresponding color difference defect compensation data based on the color difference defect data, and providing the position of the color difference defect region and the corresponding color difference defect compensation data to the augmented reality device for color difference defect compensation. According to the method for determining the color difference defect compensation data provided in the embodiments of the present invention, a color difference defect of the first image is detected by using the preset filtering algorithm; the position of the color difference defect region and the corresponding color difference defect compensation data are determined based on a detection result; the data is provided for the augmented reality apparatus, and the augmented reality apparatus can perform the method for determining the color difference defect compensation data provided in the embodiments of the present invention, to compensate for display content of an augmented reality display apparatus and obtain a compensated display picture, thereby enhancing a display effect of the augmented reality display apparatus and correcting a color difference.

### BRIEF DESCRIPTION OF THE DRAWINGS

FIG. 1 is a flowchart of a method for determining color difference defect compensation data according to an embodiment of the present invention;

FIG. 2 is a schematic diagram of a relationship between a filter and a corresponding pixel region according to an embodiment of the present invention;

FIG. 3 is a schematic diagram of a color difference defect edge convolution result according to an embodiment of the present invention;

FIG. 4 is a schematic diagram of a two-dimensional filter according to an embodiment of the present invention;

FIG. 5 is a schematic diagram of a one-dimensional filter according to an embodiment of the present invention;

FIG. 6 is a schematic diagram of a broken line graph of a filtering operation result according to an embodiment of the present invention;

FIG. 7 is a schematic diagram of a two-dimensional display region according to an embodiment of the present invention;

FIG. 8 is a schematic diagram of combination of a one-dimensional filter and a Gaussian filter according to an embodiment of the present invention;

FIG. 9 is a flowchart of a color difference defect compensation method according to an embodiment of the present invention;

FIG. 10 is a schematic structural diagram of an AR display device for compensation by using a color difference defect compensation parameter in Sapphire Rapids (SPR) in a central processing unit (CPU) according to an embodiment of the present invention;

FIG. 11 is a schematic structural diagram of an AR display device for compensation by using a color difference defect compensation parameter in a display controller according to an embodiment of the present invention;

FIG. 12 is a schematic structural diagram of an augmented reality device according to an embodiment of the present invention; and

FIG. 13 is a schematic structural diagram of an augmented reality device using a Linux Android display subsystem according to an embodiment of the present invention.

### DETAILED DESCRIPTION OF THE EMBODIMENTS

The embodiments of the present invention provide a method for determining color difference defect compensation data, a compensation method, and an augmented reality device. The preferred embodiments of the present invention will be described below with reference to the accompanying drawings. It should be understood that the preferred embodiments described here are only used to illustrate and explain the present invention and are not intended to limit the present invention. Furthermore, the embodiments of the present invention and features in the embodiments may be mutually combined without conflicts.

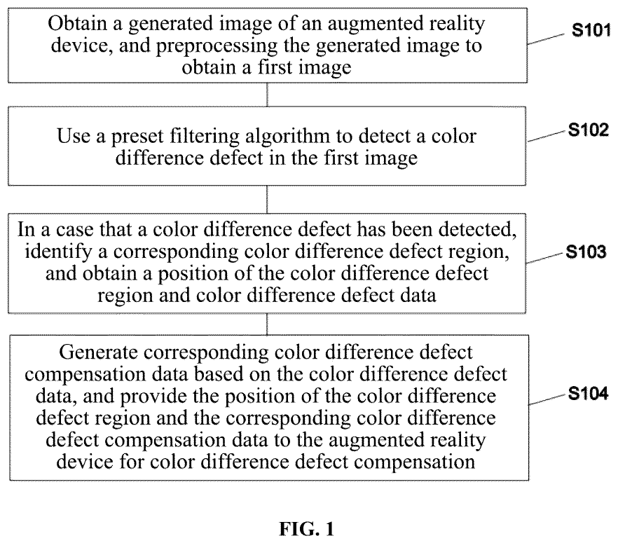

An embodiment of the present invention provides a method for determining color difference defect compensation data, as shown in FIG. 1, including:

S101. Obtain a generated image of an augmented reality device, and preprocess the generated image to obtain a first image.

S102. Use a preset filtering algorithm to detect a color difference defect in the first image.

S103. In a case that a color difference defect has been detected, identify a corresponding color difference defect region, and obtain a position of the color difference defect region and color difference defect data.

S104. Generate corresponding color difference defect compensation data based on the color difference defect data, and provide the position of the color difference defect region and the corresponding color difference defect compensation data to the augmented reality device for color difference defect compensation.

In this embodiment of the present invention, an executing entity may be a device with an image acquisition capability, an image processing capability, and a computing capability. In one possible implementation, the device may be a combination of a computer device, an imaging colorimeter, and a high-definition camera. During implementation, color difference defect detection may be performed for a panel (or a panel sample with each model number) of each assembled augmented reality device. Since the propagation and refraction of light in a waveguide material and inherent defects of a display panel may be reflected through the panel of the assembled augmented reality device, the method for determining the color difference defect compensation data provided in this embodiment of the present invention can determine color difference defect compensation data for color difference problems caused by both the waveguide and the panel itself, thereby compensating for color difference defects of the panel of the corresponding augmented reality device.

In step S101, an imaging colorimeter may be used to obtain an output image from an output end of the augmented reality device, and output an image reflecting a pixel value of the output image. The high-definition camera may be used to capture image to obtain the generated image. The imaging colorimeter may output a grayscale image and a colored image. This embodiment of the present invention will use the grayscale image for description. In one possible implementation, an original image of the output image of the augmented reality device may be a solid color image using the same pixel.

Further, the computer device obtains the generated image captured by the high-definition camera, preprocesses the image, and obtains the first image. In one possible implementation, the first image may only contain subject content (i.e., display content of the imaging colorimeter) captured by the high-definition camera.

In step S102, the computer device uses the preset filtering algorithm to detect the first image to determine the color difference defect in the first image. The color difference defect is a reflection of a display defect, caused by a waveguide and a display panel in augmented reality device, on the grayscale image of the colorimeter. The grayscale image is taken as an example. The color difference defect may be reflected in the grayscale image as a band, a point, or a ring that has a pixel value different from that in a standard grayscale.

In step S103, for various color difference defects in the first image, the computer device respectively distinguishes types of the color difference defects, determines a position and range of each color difference defect, and determines a defect degree (which may reflect a difference between a pixel value of the color difference defect and a target pixel value) corresponding to each color difference defect. In order to generate corresponding color difference defect compensation data (such as pixel compensation, average brightness, and a changed pixel value) based on different color difference defect data (such as pixel missing, nonuniform brightness, and an abnormal pixel value) in the first image and provide the position of the color difference defect region and the corresponding color difference defect compensation data to the augmented reality device in step S104, the augmented reality device uses the color difference defect compensation data for color difference defect compensation during displaying of the image.

In another embodiment provided in the present invention, step S101 of “obtaining a generated image of an augmented reality device, and preprocessing the generated image to obtain a first image” may be implemented as follows:

Step I. Obtain the generated image output by an image output end of the augmented reality device, where the generated image is acquired by using an imaging colorimeter and photographic equipment.

Step II. Detect a subject and a background of the generated image, remove the background of the generated image, and retain the subject of the generated image.

Step III. Performing image enhancement on the subject of the generated image to obtain the first image.

The image enhancement includes at least one of the following: adjusting brightness and/or contrast of the subject of the generated image; using an anti-aliasing algorithm and/or a low-pass filter to reduce a moire pattern phenomenon; using a spatial filter to smooth the image and reduce noise; and correcting image distortion.

In this embodiment of the present invention, after the computer device may be used to separate the subject from the background of the generated image, remove the background, and retain the subject, a subject part (i.e. the display content of the imaging colorimeter) of the generated image is obtained.

Further, image enhancement may be performed on the subject part of the generated image by using the following mode: For a distortion caused by the impact of an optical component in a photographing process of the high-definition camera, a distortion elimination algorithm may be used to remove the distortion from the image, to obtain an image corresponding to a true coordinate system. For moire patterns appearing in the generated image caused by interference between a sampling frequency of the high-definition camera and a display frequency of an AR display apparatus itself, the anti-aliasing algorithm may be used to smooth the moire patterns in the image. Or, the low-pass filter may be applied to eliminating moire patterns in the image by utilizing a filtering characteristic of the low-pass filter for a high-frequency signal. For deviations of brightness and contrast that are caused by waveguide transmission in the image relative to target brightness and target contrast, the computer device may adjust a gamma curve to change the brightness and contrast of the image to reach target values, so that the subsequent detection of the color difference defect in the image can reflect the color difference defect caused by the waveguide transmission, and compensate for the color difference defect through the compensation data. For image noises caused by the photographing process of the image (i.e. a process of obtaining the generated image through the imaging colorimeter and the high-definition camera) and the waveguide transmission process of the image, a filtering mode including a spatial filter is used to smooth the image and reduce the noises, to ensure accuracy of the subsequent image detection and the generated compensation data.

In another embodiment provided in the present invention, step S102 of “using a preset filtering algorithm to detect a color difference defect in the first image” may be implemented as follows:

Step I. Determine sizes of edge detection filters that respectively correspond to different color difference defects and detection thresholds that respectively correspond to different color difference defects.

Step II. For each color difference defect, traverse pixels of the first image based on the size of the edge detection filter corresponding to the color difference defect, perform convolution operation, and compare an operation result obtained in each operation with a detection threshold corresponding to the color difference defect.

Step III. In a case that the operation result satisfies the detection threshold corresponding to the color difference defect, determine that a corresponding pixel has the color difference defect.

In this embodiment of the present invention, an edge detection filter is an algorithm for image detection. Its main function is to highlight edge parts (i.e. places with significant grayscale or color changes) between different regions in the image by performing a specific operation on pixels in the image. Edge detection filters with different sizes have different detection effects and precisions. Different edge detection filters can be used for different color difference defects. A continuous range of the color difference defects can be determined by adjusting the sizes of the filters. For the operation result, a degree of the color difference defect can be determined by using the detection threshold.

Further, for different color difference defects in the first image, each pixel in the image may be traversed based on the sizes of the edge detection filters corresponding to the corresponding color difference defects. During the operation, each edge detection filter may be regarded as a fixed numeric matrix, and values in this numeric matrix are obtained according to a specific calculation formula. In one possible implementation, correspondences between the color difference defects and the sizes, as well as the detection thresholds, of the edge detection filters may be obtained based on a plurality of experiments or empirical values.

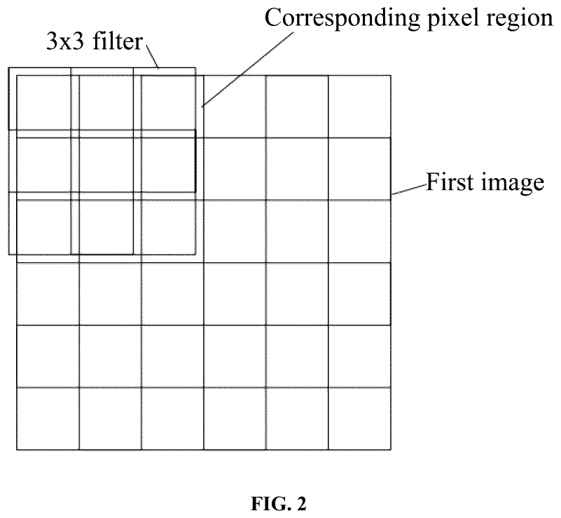

During implementation, a selected edge detection filter and a corresponding pixel region in the first image may be calculated. A size of the pixel region is related to the size of the filter, as shown in FIG. 2. For example, if the size of the filter is a 3×3 matrix, the corresponding pixel region also includes 3×3 pixels; and if the size of the filter is a 1×4 matrix, the corresponding pixel region also includes 1×4 pixels. The calculation method may be performing the convolution operation on values of the filter and pixel values in the corresponding pixel region, and the finally obtained operation result may reflect edges, pixel values, and the like of content in the image (for this embodiment of the present invention, the content is the color difference defect in the first image).

For different color difference defects, the first image is traversed respectively through the corresponding edge detection filters. During the traversing, the operation result obtained in each convolution operation is compared with the detection threshold of the corresponding color difference defect. Whether there is a color difference defect of this type can be determined based on a comparison result.

In still another embodiment provided in the present invention, step S103 of in a case that a color difference defect has been detected, identifying a corresponding color difference defect region, and obtaining a position of the color difference defect region and color difference defect data may be implemented as follows:

Step I. For each color difference defect, in a case that it is determined that a first pixel of the first image has the color difference defect, determine position coordinates of the first pixel having the color difference defect in the first image.

Step II. Determine the color difference defect region with the color difference defect and the position of the color difference defect region in the first image based on a positional relationship between the position coordinates of the first pixel.

Step III. Determine the color difference defect data corresponding to the color difference defect region based on a display index value of a pixel within the color difference defect region.

The color difference defect may include: a point color difference defect, a line color difference defect, and a band color difference defect; the edge detection filter corresponding to the point color difference defect includes a one-dimensional filter; and the edge detection filters corresponding to non-point color difference defects include one-dimensional filters.

In this embodiment of the present invention, each convolution calculation of the edge detection filter corresponding to each color difference defect is performed on a pixel corresponding to a current convolution, and a region with a color difference defect usually includes pixels corresponding to a plurality of convolutions. Therefore, the region with the color difference defect needs to be determined based on results of the plurality of convolutions. During implementation, positions of first pixels of the first image having the same color difference defect may be integrated (for example, a region composed of continuous first pixels is determined as the same color difference defect region), and at least one color difference defect region composed of these first pixels may be determined.

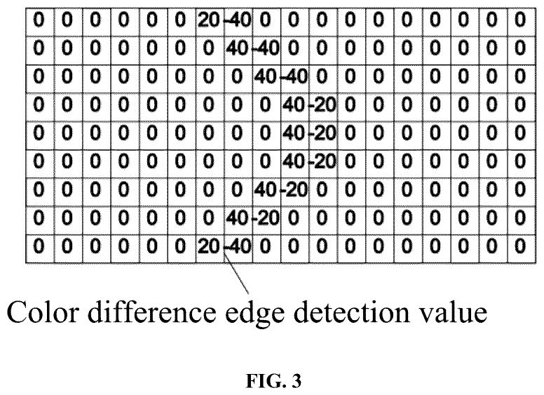

The detection process uses zero crossing points in an output result (i.e. a result obtained by performing convolution operation on the values of the edge detection filter and the pixel values in the corresponding pixel region) of the edge detection filter, as shown in FIG. 3, to detect edges of the color difference defect region in the first image. These zero crossing points mean that positions at which symbols of second derivatives in the pixel values of the image change, and these positions correspond to edges of the image.

In a case that the edges of the image have been detected, first pixels of the first image corresponding to the positions are first determined, and the first pixels are determined as edge pixels of the corresponding color difference defect.

The color difference defect region, in which the corresponding color difference is located, in the first image is determined based on the positional relationship between the obtained position coordinates of the first pixels. A point color difference defect is taken as an example. Since the point color difference defect is usually a point region formed by a plurality of adjacent pixels, by analyzing positional relationships of these pixels, the pixels can be combined together to form a complete point region (i.e. a point color difference defect region).

Further, the edge pixels of the determined color difference defect region are confirmed; a range of relative coordinate values of the color difference defect region on the first image is identified; the position of the defect in the first image is confirmed; and the corresponding position of the color difference defect region on the display panel of the AR display apparatus is then obtained.

Further, the display index values of the pixels within the color difference defect region are analyzed to determine the color difference defect data corresponding to the region. The display index values may include a pixel value, brightness, contrast, and other information. By analyzing these indexes and comparing the indexes with target display index values, corresponding adjustment is performed. For example, if the brightness of the region is less than target brightness, the brightness of the region is increased to the target brightness and an increased brightness value is recorded as subsequent color difference defect compensation data.

Further, in this embodiment of the present invention, the color difference defects may be classified into a point color difference defect, a line color difference defect, and a band color difference defect based on shapes of the color difference defects.

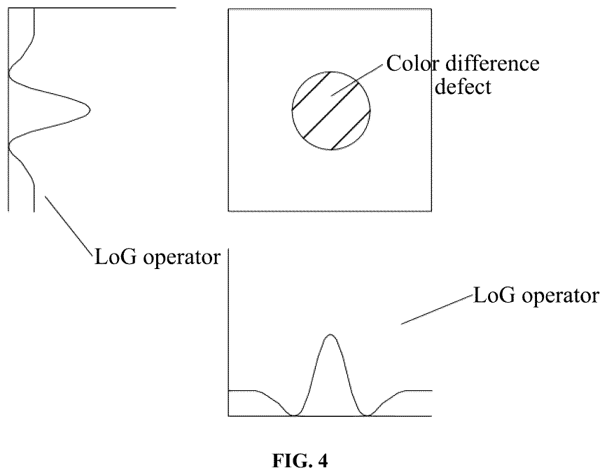

For the point color difference defect (namely, which is displayed as approximately circular or similarly spot-like continuous regions that have similar pixel values in the first image), the corresponding edge detection filter may be a two-dimensional filter. The two-dimensional filter may be a Laplacian of Gaussian (LoG) filter as shown in FIG. 4, which is a LoG operator in both X and Y directions of the filter. An expression of the LoG operator is shown in the following formula.

$$LoG = {∇}^{2} G ( x , y ) = \frac{1}{{σ}^{4}} ( \frac{{x}^{2} + {y}^{2}}{{σ}^{2}} - 2 ) exp [ \frac{- ( {x}^{2} + {y}^{2} )}{2 {σ}^{2}} ]$$

Where ∇² represents a Laplacian operator which calculates a sum of the second-order partial derivatives of a function; and G(x, y) represents a Gaussian function, where σ represents a standard deviation of the Gaussian function for controlling a width of the Gaussian function. The LoG operator is obtained by calculating the second-order partial derivatives of the Gaussian function and organizing the second-order partial derivatives. The LoG operator is mainly used for edge detection in image processing and computer vision, which can highlight regions, in which grayscale values change rapidly, in the image, and these regions usually correspond to edges and details of the image. By adjusting the value of the standard deviation σ, scales of the detected edges and degrees of the detected details can be controlled. Based on a smaller value of σ, edges and details that have smaller range scales will be detected. Based on a larger value of σ, edges having a larger range scale will be detected. Adjusting the value of σ can change the size of the corresponding filter formed by the operator, thereby implementing detection on color difference defect regions with different scales.

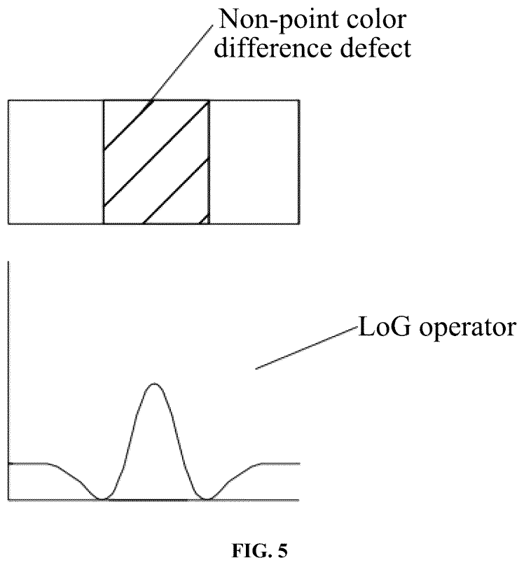

For a non-point color difference defect, a one-dimensional filter may be used, which may be a filter formed by a LoG operator in an X-axis direction or a Y-axis direction as shown in FIG. 5, or may be a filter formed by combining a LoG operator and a Gaussian operator. The one-dimensional filter may selectively detect features in a particular direction.

Filters with different sizes are suitable for different color difference defects. For the line color difference defect and the band color difference defect, sizes of the corresponding one-dimensional filters and corresponding detection thresholds are not the same (the corresponding detection thresholds may be obtained based on a plurality of experiments or empirical values). The sizes of the corresponding one-dimensional filters are used to traverse the pixels of the first image in either the X-axis direction or the Y-axis direction. In one possible implementation, for continuously long color difference defects in the X-axis direction, a filter with a larger size in the X-axis direction may be used for operation.

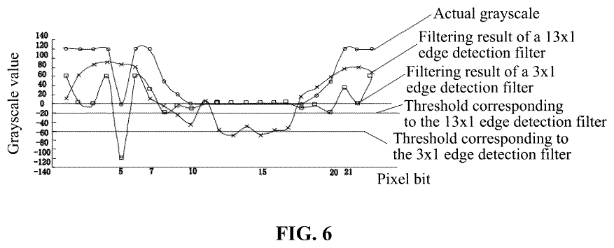

In this embodiment of the present invention, an example is further provided to describe differences in capabilities of one-dimensional filters with different sizes to detect defects with different sizes, as shown in FIG. 6. FIG. 6 is a schematic diagram of a broken line graph of a result obtained by performing a filtering operation on a display region with a width of one pixel in the first image by using filters with different sizes. The broken lines respectively represent an actual grayscale of the display region, a processing result of a 3×1 edge detection filter, and a processing result of a 13×1 edge detection filter. After the display region is processed by the edge detection filter with the size of 3×1, a color difference defect (since its grayscale value exceeds a detection threshold corresponding to the 3×1 edge detection filter) correspondingly detected by the 3×1 edge detection filter may be displayed at a fifth pixel bit of the display region. In this detection, defects at pixel bits 7 to 21 in the display region may not be highlighted (only partial edge regions of the defects can be reflected).

After the display region is processed by the edge detection filter with the size of 13×1, the color difference defect corresponding to the fifth pixel bit of the display region may not be displayed, but color difference defects corresponding to the 13×1 edge detection filter corresponding to pixel bits 7 to 21 of the display region may be highlighted (since their grayscale values exceed a detection threshold corresponding to the 13×1 edge detection filter).

In yet another embodiment provided by the embodiments of the present invention, step S104 of generating corresponding color difference defect compensation data based on the color difference defect data, and providing the position of the color difference defect region and the corresponding color difference defect compensation data to the augmented reality device for color difference defect compensation may be implemented as:
Step 1. For each first pixel in each color difference defect region, determine, based on a preset compensation mode from pixels that are adjacent to the first pixel and have no color difference defect, pixel values and position coordinates of at least two second pixels having a preset positional relationship with the first pixel.

Step 2. Determine color difference defect compensation data corresponding to the first pixel based on a pixel value and position coordinates of the first pixel and the pixel values and position coordinates of the second pixels.

Step 3. Determine, in the color difference defect region, color difference defect subregions corresponding to first pixels having close color difference defect compensation data.

Step 4. Provide positions of the color difference defect subregion and corresponding color difference defect compensation data to the augmented reality device for color difference defect compensation.

In this embodiment of the present invention, after the position and range of each color difference defect region are determined, a computer system uses the preset compensation mode to calculate a compensation value for the corresponding color difference defect region.

In one possible implementation, in order to make a display effect smoother, the computer system may obtain a coordinate range of the corresponding color difference defect region and coordinates and pixel values of pixels (i.e. the second pixels) that are nearest to an edge (i.e. the first pixel on the outermost side of the color difference defect region) of the color difference defect region. An interpolation algorithm can be used to obtain the color difference defect compensation data of the first pixel within the color difference defect region based on the pixel value and position coordinates of the first pixel, as well as the pixel values and position coordinates of the second pixels.

In a practical application process, the color difference defect region may be divided into a plurality of color difference defect subregions, and the first pixels in each color difference defect subregion have a particular correlation (for example, the color difference compensation data is similar. That is, if the values of the color difference compensation data are within a preset range, it can be considered that the color difference compensation data is similar). For each color difference defect subregion, the color difference compensation data of any first pixel within the color difference defect subregion may be used as color difference compensation data of the color difference defect subregion. The AR display apparatus may use this color difference compensation data to uniformly compensate for the first pixels within the color difference defect subregion. In this way, the AR display apparatus may store correspondences between the color difference defect subregions and the color difference compensation data, rather than the correspondences between the first pixels and the color difference compensation data, so that the efficiency of color difference compensation is improved, and occupation of an internal memory of the AR apparatus is reduced.

In still yet another embodiment provided by the embodiments of the present invention, step 1 of “for each first pixel in each color difference defect region, determining, based on a preset compensation mode from pixels that are adjacent to the first pixel and have no color difference defect, pixel values and position coordinates of at least two second pixels having a preset positional relationship with the first pixel” may be implemented as follows:
in a case that the preset compensation mode employs a one-dimensional compensation mode, for each first pixel in each color difference defect region, determining, from the pixels that are adjacent to the first pixel and have no color difference defect, pixel values and one-dimensional position coordinates of at least two second pixels with one-dimensional coordinate values respectively less than and greater than a one-dimensional coordinate value of the first pixel; and
in a case that the preset compensation mode employs a two-dimensional compensation mode, for each first pixel in each color difference defect region, respectively determining, from the pixels that are adjacent to the first pixel and have no color difference defect, pixel values and two-dimensional position coordinates of a plurality of second pixels, the two-dimensional position coordinates of the plurality of second pixels satisfying: connecting the plurality of second pixels in sequence is able to surround the first pixel.

In this embodiment of the present invention, the preset compensation mode may include a one-dimensional compensation mode and a two-dimensional compensation mode. The one-dimensional compensation mode is mainly to: for the one-dimensional coordinates of the first pixel (for a first pixel with two-dimensional coordinates, one-dimensional coordinates of the two-dimensional coordinates may be selected), determine the at least two second pixels from adjacent pixels without color free defects in a dimension at which the one-dimensional coordinates are located. An example in which two second pixels are determined is used. In order to make the display effect smoother after the compensation for the first pixel, the two second pixels may be selected from two sides of the first pixel. For example, the one-dimensional coordinates of the two second pixels are respectively greater than and less than the one-dimensional coordinates of the first pixel. The two-dimensional compensation mode is mainly to: for the two-dimensional coordinates of the first pixel, determine the plurality of second pixels from pixels without color difference defects around the first pixel. An example in which four second pixels are determined is used. In order to make the display effect smoother after the compensation for the first pixel, the four second pixels may be selected from a top left corner, a top right corner, a bottom left corner, and a bottom right corner of the first pixel. The following examples are used for explanation:

For a band display region with a width of one pixel, the one-dimensional compensation mode may be used to determine the pixel values and position coordinates of the two second pixels. Then, the color difference defect compensation data corresponding to the first pixel may be determined based on the pixel value and position coordinates of the first pixel, as well as the pixel values and position coordinates of the two second pixels. The one-dimensional compensation mode used may be a single linear interpolation algorithm as shown in the following formula:

$${Y}_{out} = {y}_{1} + \frac{( {y}_{2} - {y}_{1} )}{( {x}_{2} - {x}_{1} )} \times ( {x}_{in} - {x}_{1} )$$

where yₒᵤₜ represents output color difference defect compensation data; x₁ and x₂ respectively represent the coordinate values of the two second pixels within the display region, and the two coordinates may be points nearest to the color difference defect region; y₁ and y₂ represent the pixel values of the two second pixels; and xᵢₙ represent a coordinate value of the first pixel in the color difference defect region. It is assumed that x₁=0, x₂=10, y₁=100, y₁=150, and xᵢₙ=5. Yₒᵤₜ=125 may be obtained based on the one-dimensional interpolation algorithm. The value is the color difference defect compensation data corresponding to a first pixel with a coordinate value of 5 in the display region. The computer system records the value and the corresponding coordinate value, and provides the value and the corresponding coordinate value to the augmented reality display apparatus for color difference defect compensation.

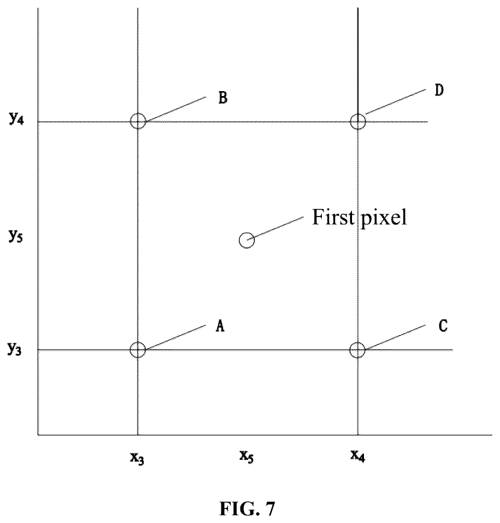

For a two-dimensional display region, the two-dimensional compensation mode may be used to determine the pixel values and position coordinates of the four second pixels. Then, the color difference defect compensation data corresponding to the first pixel may be determined through the interpolation algorithm based on the pixel value and position coordinates of the first pixel, as well as the pixel values and position coordinates of the four second pixels. For the two-dimensional display region shown in FIG. 7, the two-dimensional compensation mode used may be a bilinear interpolation algorithm as shown in the following formula:

$${P}_{out} = \frac{( {x}_{4} - {x}_{5} ) ( {y}_{4} - {y}_{5} )}{( {x}_{4} - {x}_{3} ) ( {y}_{4} - {y}_{3} )} {Q}_{A} + \frac{( {x}_{5} - {x}_{3} ) ( {y}_{4} - {y}_{5} )}{( {x}_{4} - {x}_{3} ) ( {y}_{4} - {y}_{3} )} {Q}_{C} + \frac{( {x}_{4} - {x}_{5} ) ( {y}_{5} - {y}_{3} )}{( {x}_{4} - {x}_{3} ) ( {y}_{4} - {y}_{3} )} {Q}_{B} + \frac{( {x}_{5} - {x}_{3} ) ( {y}_{5} - {y}_{3} )}{( {x}_{4} - {x}_{3} ) ( {y}_{4} - {y}_{3} )} {Q}_{D}$$

where coordinates of the four selected second pixels are A (x₃, y₃), B (x₃, y₄), C (x₄, y₃, and D (x₄, y₄). Values of the four second pixels are respectively Q_{A}, Q_{B}, Q_{C}, and Q_{D}; the coordinates of the first pixel for which color difference defect compensation data is to be obtained are (x₅, y₅); and Pₒᵤₜ represents the output color difference defect compensation data.

An example in which the values of x₃=0, x₄=2, y₃=0, y₄=2, Q_{A}, Q_{B}, Q_{C}, and Q_{D} are respectively 150, 160, 145, and 150 is used. If the coordinates of the first pixel for which color difference defect compensation data is to be obtained are (1,1), Pₒᵤₜ=151.25 can be obtained. This value is the color difference defect compensation data corresponding to the first pixel with the coordinates of (1,1) in the display region.

In still another embodiment provided in the present invention, step S102 of “using a preset filtering algorithm to detect a color difference defect in the first image” may further include the following steps:
using a smoothing filter to traverse pixels of the first image and perform convolution operation, to smooth an edge of the color difference defect in the first image, where the smoothing filter includes a two-dimensional filter; alternatively, in a case that the edge detection filter is a one-dimensional filter, the smoothing filter is used as another one dimension to form a two-dimensional filter with the edge detection filter.

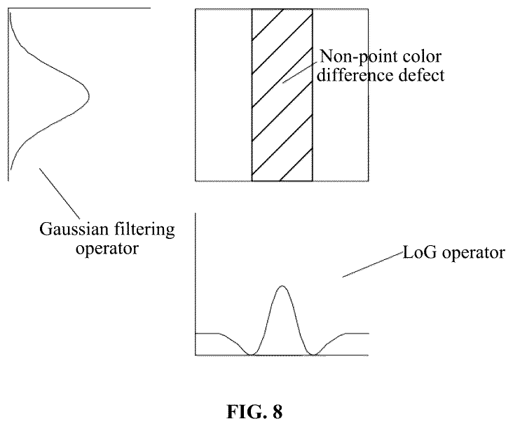

In this embodiment of the present invention, the smoothing filter may be a Gaussian filter. In one possible implementation, FIG. 8 shows a combination of the smoothing filter and edge detection filter. FIG. 8 shows a filter formed by a LoG operator in an X-axis direction and a Gaussian filtering operator in a Y-axis direction.

In the process of using a filter to detect an edge, if the edges of the color difference defects in the first image are low in continuity, a function level set of a detection operator (the LoG operator is taken as an example in this embodiment of the present invention) will fail to converge, thereby affecting the detection capability of the filter. The Gaussian filtering operator can be used to perform the convolution operation first to smooth the edges of the corresponding color difference defects, improve the continuity of the edges of the color difference defects, and help improve the detection precision. Furthermore, compared to other smoothing filters such as a mean filter, the Gaussian filter has less impact on the image and can retain more image features.

In the implementation process of this combined filter, the smoothing filter is first used to smooth a pixel region corresponding to the filter, and then edge detection is performed in step S102. The edge detection capability can be improved, and the impact of factors such as edge discontinuity on a detection result can be eliminated.

In yet still another embodiment provided in the present invention, for each color difference defect, the following modes may be used to determine the detection threshold corresponding to the color difference defect:

Step I. For each color difference defect, compare, by edge detection filters with the same size for the color difference defect, different candidate detection thresholds with corresponding operation results to obtain different comparison results.

Step II. Use a preset edge detection algorithm to compare the color difference defect that is determined based on the comparison result of each candidate detection threshold with a corresponding color difference defect region in the first image, to determine valid degrees of the candidate detection thresholds for detecting the corresponding color difference defect.

Step III. Determine a candidate detection threshold with a highest valid degree as the detection threshold corresponding to the color difference defect.

In this embodiment of the present invention, different thresholds may correspond to edge detection filters with different sizes to detect different color difference defects. Edge detection filters with each size correspond to different detection thresholds.

Due to the determination of the detection threshold, binary processing can be applied to the output image of the edge detection filter by using the candidate detection thresholds (that is, a part greater than the candidate detection threshold may be considered as a maximum pixel value, and a part less than the candidate detection threshold may be considered as a minimum pixel value), to form a visual result. This result is combined with other edge detection methods (such as a Canny algorithm) to determine accuracy of color difference defect detection of the result; the candidate detection threshold that can accurately detect the color difference defect corresponding to the filter is finally obtained; and the candidate detection threshold is determined as the detection threshold finally corresponding to the edge detection filter.

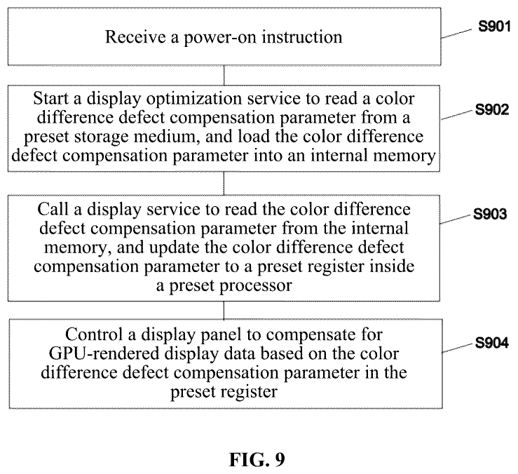

An embodiment of the present invention further provides a color difference defect compensation method, as shown in FIG. 9, which may be implemented as follows:

S901. Receive a power-on instruction.

S902. Start a display optimization service to read a color difference defect compensation parameter from a preset storage medium, and load the color difference defect compensation parameter into a memory, where the color difference defect compensation parameter includes: a position and color difference defect compensation data of a color difference defect region.

S903. Call a display service to read the color difference defect compensation parameter from the internal memory, and update the color difference defect compensation parameter to a preset register inside a preset processor.

S904. Control a display panel to compensate for GPU-rendered display data based on the color difference defect compensation parameter in the preset register,
where the color difference defect compensation parameter is determined based on the method for determining the color difference defect compensation data in any one of the above embodiments.

In this embodiment of the present invention, an executing subject may be an AR display device that has a display function and uses a preset color difference compensation parameter to correct display content.

In one possible implementation, after the AR display device is started, the display optimization service may be first started. The service may read the color difference defect compensation parameter from the preset storage medium. The preset storage medium may be a hard disk, a solid state disk, a flash memory, or another storage device. The storage device stores the color difference defect compensation parameter. The parameters include the position of the color difference defect region and the color difference defect compensation data. The position of the color difference defect region is used to determine a specific position that needs to be compensated in the display panel of the AR display device, and the color difference defect compensation data includes information required by optimization of these color difference defect regions, such as a pixel correction value and a contrast adjustment value.

Further, the color difference defect compensation parameter may be loaded into the internal memory from the preset storage medium, and the display service for displaying corresponding content in the AR display device is called from the AR display device.

The display service may read the previously loaded color difference defect compensation parameter from the internal memory, and update the color difference defect compensation parameter to the preset register (such as a special purpose register in the figure) inside the preset processor. The preset register is an internal storage unit of the processor, and is configured to enable the processor to quickly read the color difference defect compensation parameter during performing of a color difference correction operation.

Further, the GPU-rendered display data is compensated for. A GPU is usually responsible for image rendering in the AR display device and transmitting rendered image data to the display panel for displaying, and the display panel may perform a compensation operation on the display content based on the color difference defect compensation parameter in the preset register. The preset register may be a special purpose register (SPR) with a color difference defect compensation function inside the GPU.

Optionally, for an AR display device without a GPU or the GPU that does not include the SPR module, a driver chip of a display controller in the AR display device may read the color difference defect compensation parameter from the register of the processor to optimize a display effect. The method improves the platform compatibility.

In another embodiment provided by the present invention, a first compensation parameter storage register is provided in a data processing unit (DPU).

Step S903 of “calling a display service to read the color difference defect compensation parameter from the internal memory, and updating the color difference defect compensation parameter to a preset register inside a preset processor” may be implemented as follows:
calling the display service to read the color difference defect compensation parameter from the internal memory, and updating the color difference defect compensation parameter to the first compensation parameter storage register in the DPU.

Step S904 of “controlling a display panel to compensate for GPU-rendered display data based on the color difference defect compensation parameter in the preset register” includes:

Step 1. Transmit the color difference defect compensation parameter in the first compensation parameter register to a preset internal memory of a display controller in the display panel through a mobile industry processor interface (MIPI) bus.

Step 2. Compensate, by the display controller, for the GPU-rendered display data based on the color difference defect compensation parameter in the preset memory.

In still another embodiment provided in the present invention, a second compensation parameter storage register is configured in the display controller of the display panel.

Step S903 of “calling a display service to read the color difference defect compensation parameter from the internal memory, and updating the color difference defect compensation parameter to a preset register inside a preset processor” may be implemented as:

Step I. Call the display service to read the color difference defect compensation parameter from the internal memory, and updating the color difference defect compensation parameter to a memory of the display panel.

Step II. Read the color difference defect compensation parameter to the second compensation parameter storage register inside the display controller through the display controller.

Step S804 of “controlling a display panel to compensate for GPU-rendered display data based on the color difference defect compensation parameter in the preset register” may be implemented as follows:
controlling the display panel to compensate for the GPU-rendered display data based on the color difference defect compensation parameter in the second compensation parameter storage register.

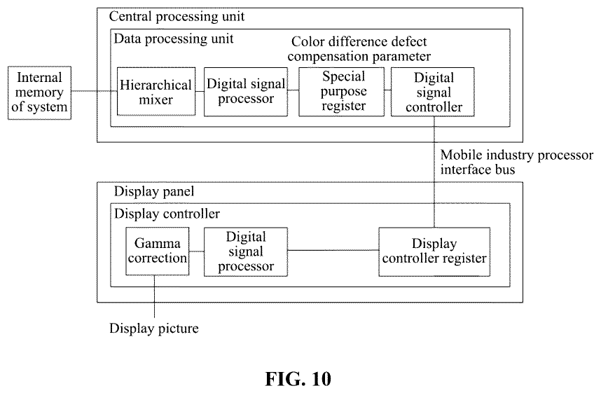

In this embodiment of the present invention, FIG. 10 is a schematic structural diagram of an AR display device for compensation by using a color difference defect compensation parameter in SPR in a central processing unit (CPU) according to an embodiment of the present invention. In a case that there is SPR for color difference compensation operation in a DPU of the CPU in the AR display device, a color difference defect compensation parameter is registered in the SPR (namely, the first compensation parameter register). When an image compensation operation is required, the color difference defect compensation parameter is called to the preset internal memory of the display controller in the display panel through the MIPI bus.

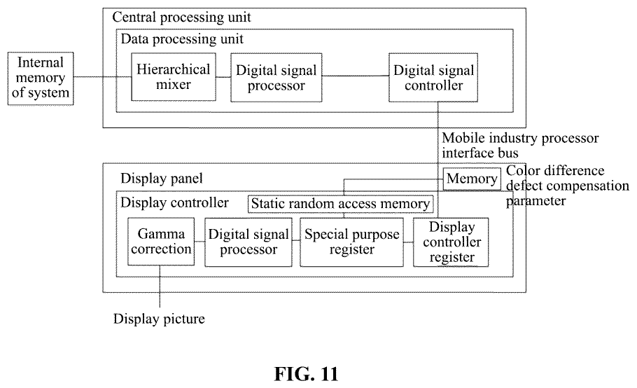

Optionally, FIG. 11 is a schematic structural diagram of an AR display device for compensation by using a color difference defect compensation parameter in a display controller. For the situation in which the second compensation parameter storage register is configured in the display controller of the display panel in the AR display device, the color difference defect compensation parameter is registered in the second compensation parameter storage register, and is called by the display controller from the register to compensate for the display data.

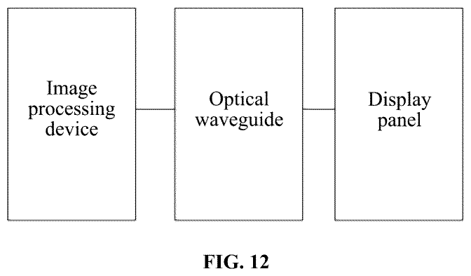

The present invention further provides an augmented reality device, as shown in FIG. 12, including: a display panel, an optical waveguide, and an image processing device.

The optical waveguide is configured to transmit content displayed on the display panel to the eyes of a user.

The image processing device is configured to: drive the display panel, store a color difference defect compensation parameter, and use the color difference defect compensation method in the above embodiment to compensate for data displayed by the display panel.

In this embodiment of the present invention, in one possible implementation, an AR display device platform reads and loads the color difference defect compensation parameter, and writes the parameter into a hardware abstraction layer through a system application programming interface (API). Based on different hardware of the platform, a GPU may be used for color difference compensation, or the color difference defect compensation parameter is loaded and read through a display controller of the display panel, or a color difference compensation effect is achieved on the display controller.

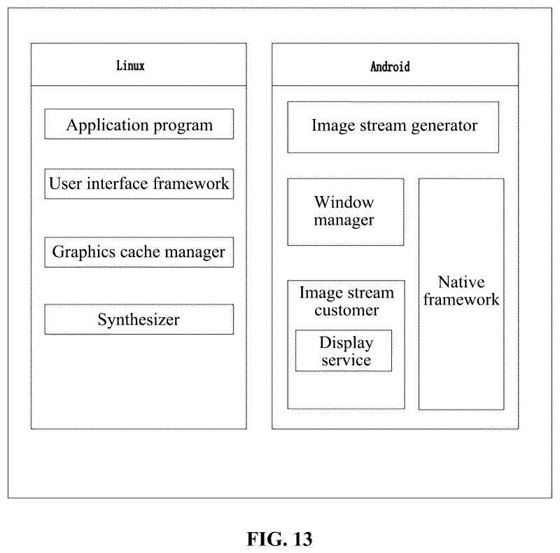

As shown in FIG. 13, a possible implementation of an AR display device using a Linux Android display subsystem is described. In this implementation, a DPU implements gamma correction, hue calibration, a color difference compensation effect, and other processing. A hardware abstraction layer may perform interface packaging on a display module. After an Android system is started, a display service may be run. The display service may read a color difference defect compensation parameter in an embedded multi-media card/universal flash storage (EMMC/UFS). The display service then calls an interface of the hardware abstraction layer and issues the color difference defect compensation parameter through the interface to complete a color difference correction process.

Through the description of the above implementations, those skilled in the art can clearly understand that the embodiments of the present invention can be implemented by relying on hardware or software and essential general-purpose hardware platforms, or by relying on hardware. Based on this understanding, the technical solutions of the embodiments of the present invention can be embodied in the form of a software product. The software product can be stored in a non-volatile storage medium (such as a compact disc-read only memory (CD-ROM), a USB flash disk (U disk), and a portable hard disk drive), including a plurality of instructions for causing a computer device (which can be a personal computer, a server, a network device, or the like) to perform the method of the embodiments of the present invention.

Those skilled in the art can understand that the accompanying drawings are only a schematic diagram of a preferred embodiment, and the modules or processes in the accompanying drawings are not necessarily necessary for implementing the present invention.

Those skilled in the art can understand that the modules in the apparatus described in the embodiments can be distributed in the apparatus described in the embodiments, or can be changed correspondingly to be located in one or more apparatuses different from this embodiment. The modules of the above embodiments can be merged into one module or further split into a plurality of sub-modules.

The sequential numbers of the foregoing embodiments of the present invention are merely for description purpose but do not imply the preference of the embodiments.

Apparently, those skilled in the art that various changes and transformations can be made in the present invention without departing from the spirit and scope of the present invention. Thus, if these changes and transformations of the present invention are within the scope of the claims of the present invention and their equivalents, the present invention is also intended to encompass these changes and transformations.

What is claimed is:

1. A method for determining color difference defect compensation data, comprising:
obtaining a generated image of an augmented reality device, and preprocessing the generated image to obtain a first image;
using a preset filtering algorithm to detect a color difference defect in the first image;
in a case that a color difference defect has been detected, identifying a corresponding color difference defect region, and obtaining a position of the color difference defect region and color difference defect data; and
generating corresponding color difference defect compensation data based on the color difference defect data, and providing the position of the color difference defect region and the corresponding color difference defect compensation data to the augmented reality device for color difference defect compensation.

2. The method according to claim 1, wherein the obtaining a generated image of an augmented reality device, and preprocessing the generated image to obtain a first image comprises:
obtaining the generated image output by an image output end of the augmented reality device, wherein the generated image is acquired by using an imaging colorimeter and photographic equipment;
detecting a subject and a background of the generated image, removing the background of the generated image, and retaining the subject of the generated image; and
performing image enhancement on the subject of the generated image to obtain the first image,
wherein the image enhancement comprises at least one of the following: adjusting brightness and/or contrast of the subject of the generated image; using an anti-aliasing algorithm and/or a low-pass filter to reduce a moire pattern phenomenon; using a spatial filter to smooth the image and reduce noise; and correcting image distortion.

3. The method according to claim 1, wherein the using a preset filtering algorithm to detect a color difference defect in the first image comprises:
determining sizes of edge detection filters that respectively correspond to different color difference defects and detection thresholds that respectively correspond to different color difference defects;
for each color difference defect, traversing pixels of the first image based on the size of the edge detection filter corresponding to the color difference defect, performing convolution operation, and comparing an operation result obtained in each operation with the detection threshold corresponding to the color difference defect; and
in a case that the operation result satisfies the detection threshold corresponding to the color difference defect, determining that a corresponding pixel has the color difference defect.

4. The method according to claim 3, wherein in a case that a color difference defect has been detected, the identifying a corresponding color difference defect region, and obtaining a position of the color difference defect region and color difference defect data comprises:
for each color difference defect, in a case that it is determined that a first pixel of the first image has the color difference defect, determining position coordinates of the first pixel having the color difference defect in the first image;
determining the color difference defect region with the color difference defect and the position of the color difference defect region in the first image based on a positional relationship between the position coordinates of the first pixel; and
determining the color difference defect data corresponding to the color difference defect region based on a display index value of a pixel within the color difference defect region; and/or
the color difference defect comprises: a point color difference defect, a line color difference defect, and a band color difference defect; the edge detection filter corresponding to the point color difference defect comprises a one-dimensional filter; and the edge detection filters corresponding to the line color difference defect and the band color difference defect comprise one-dimensional filters.

5. The method according to claim 1, wherein the generating corresponding color difference defect compensation data based on the color difference defect data, and providing the position of the color difference defect region and the corresponding color difference defect compensation data to the augmented reality device for color difference defect compensation comprises:
for each first pixel in each color difference defect region, determining, based on a preset compensation mode from pixels that are adjacent to the first pixel and have no color difference defect, pixel values and position coordinates of at least two second pixels having a preset positional relationship with the first pixel;
determining color difference defect compensation data corresponding to the first pixel based on a pixel value and position coordinates of the first pixel and the pixel values and position coordinates of the second pixels;
determining, in the color difference defect region, color difference defect subregions corresponding to first pixels having close color difference defect compensation data; and
providing positions of the color difference defect subregion and corresponding color difference defect compensation data to the augmented reality device for color difference defect compensation.

6. The method according to claim 5, wherein the for each first pixel in each color difference defect region, determining, based on a preset compensation mode from pixels that are adjacent to the first pixel and have no color difference defect, pixel values and position coordinates of at least two second pixels having a preset positional relationship with the first pixel comprises:
in a case that the preset compensation mode employs a one-dimensional compensation mode, for each first pixel in each color difference defect region, determining, from the pixels that are adjacent to the first pixel and have no color difference defect, pixel values and one-dimensional position coordinates of at least two second pixels with one-dimensional coordinate values respectively less than and greater than a one-dimensional coordinate value of the first pixel; and
in a case that the preset compensation mode employs a two-dimensional compensation mode, for each first pixel in each color difference defect region, respectively determining, from the pixels that are adjacent to the first pixel and have no color difference defect, pixel values and two-dimensional position coordinates of a plurality of second pixels, the two-dimensional position coordinates of the plurality of second pixels satisfying: connecting the plurality of second pixels in sequence is able to surround the first pixel.

7. The method according to claim 3, further comprising:
using a smoothing filter to traverse pixels of the first image and perform convolution operation, to smooth an edge of the color difference defect in the first image, wherein the smoothing filter comprises a two-dimensional filter; alternatively, in a case that the edge detection filter is a one-dimensional filter, the smoothing filter is used as another one-dimensional filter to form a two-dimensional filter with the edge detection filter, and/or
for each color difference defect, using the following mode to determine the detection threshold corresponding to the color difference defect:
for each color difference defect, comparing, by edge detection filters with the same size for the color difference defect, different candidate detection thresholds with corresponding operation results to obtain different comparison results;
using a preset edge detection algorithm to compare the color difference defect that is determined based on the comparison result of each candidate detection threshold with a corresponding color difference defect region in the first image, to determine valid degrees of the candidate detection thresholds for detecting the corresponding color difference defect; and
determining a candidate detection threshold with a highest valid degree as the detection threshold corresponding to the color difference defect.

8. A color difference defect compensation method, comprising:
receiving a power-on instruction;
starting a display optimization service to read a color difference defect compensation parameter from a preset storage medium, and loading the color difference defect compensation parameter into an internal memory, wherein the color difference defect compensation parameter comprises: a position and color difference defect compensation data of a color difference defect region;
calling a display service to read the color difference defect compensation parameter from the internal memory, and updating the color difference defect compensation parameter to a preset register inside a preset processor; and
controlling a display panel to compensate for graphics processing unit (GPU)-rendered display data based on the color difference defect compensation parameter in the preset register,
wherein the color difference defect compensation parameter is determined based on the method for determining the color difference defect compensation data according to claim 1.

9. The method according to claim 8, wherein a first compensation parameter storage register is configured in a data processing unit (DPU);
the calling a display service to read the color difference defect compensation parameter from the internal memory, and updating the color difference defect compensation parameter to a preset register inside a preset processor comprises:
calling the display service to read the color difference defect compensation parameter from the internal memory, and updating the color difference defect compensation parameter to the first compensation parameter storage register in the DPU;
the controlling a display panel to compensate for GPU-rendered display data based on the color difference defect compensation parameter in the preset register comprises:
transmitting the color difference defect compensation parameter in the first compensation parameter register to a preset internal memory of a display controller in the display panel through a mobile industry processor interface (MIPI) bus;
the display controller compensates for the GPU-rendered display data based on the color difference defect compensation parameter in the preset memory; or
a second compensation parameter storage register is configured in the display controller of the display panel;
the calling a display service to read the color difference defect compensation parameter from the internal memory, and updating the color difference defect compensation parameter to a preset register inside a preset processor comprises:
calling the display service to read the color difference defect compensation parameter from the internal memory, and updating the color difference defect compensation parameter to a memory of the display panel; and
reading the color difference defect compensation parameter to the second compensation parameter storage register inside the display controller through the display controller; and
the controlling a display panel to compensate for GPU-rendered display data based on the color difference defect compensation parameter in the preset register comprises:
controlling the display panel to compensate for the GPU-rendered display data based on the color difference defect compensation parameter in the second compensation parameter storage register.

10. An augmented reality device, comprising: a display panel, an optical waveguide, and an image processing device,
wherein the optical waveguide is configured to transmit content displayed on the display panel to the eyes of a user; and
the image processing device is configured to: drive the display panel, store a color difference defect compensation parameter, and use the color difference defect compensation method according to claim 8 to compensate for data displayed by the display panel.
